(19) United States
(12) Patent Application Publication
(10) Pub. No.: US 2026/0230127 A1
(43) Pub. Date: Aug. 6, 2026

(54) CODEBOOK ENHANCEMENT TRANSMISSION METHOD AND APPARATUS

(71) Applicant: ZTE CORPORATION, Shenzhen, Guangdong (CN)

(72) Inventors: Ke YAO, Shenzhen (CN); Bo GAO, Shenzhen (CN); Yang ZHANG, Shenzhen (CN); Meng MEI, Shenzhen (CN)

(21) Appl. No.: 19/149,245

(22) PCT Filed: Jan. 20, 2023
(86) PCT No.: PCT/CN2023/073443

§ 371 Date: Jul. 18, 2025

(51) Int. Cl. H04B 7/0456

(52) U.S. Cl. CPC H04B 7/0456

(57) ABSTRACT

This disclosure is directed to methods, systems, and devices related to wireless communication, and more specifically, to support high capability user equipment and to improve uplink (UL) quality. A method of wireless communication includes receiving, by a wireless communication device, from a wireless communication node, one or more precoder indications, where each of the precoder indication corresponds to one or more port groups. The method further includes determining, by the wireless communication device, a precoder for a transmission according to the one or more precoder indications.

### CROSS-REFERENCE TO RELATED APPLICATION

The present disclosure is a national stage filing under 35 U.S.C. § 371 of international application number PCT/CN2023/073443, filed on Jan. 20, 2023, which is incorporated herein by reference in its entirety.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems.

In one example aspect, a wireless communication method is disclosed. The method includes receiving, by a wireless communication device, from a wireless communication node, one or more precoder indications; wherein each of the precoder indication corresponds to one or more port groups; and determining, by the wireless communication device, a precoder for a transmission according to the one or more precoder indications.

In another example aspect, another wireless communication method is disclosed. The method includes transmitting, to the wireless communication device, from a wireless communication node, one or more precoder indications; wherein each of the precoder indication corresponds to one or more port groups.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 an example of determination of a number of candidate codebook set for each rank.

FIG. 2 is a flowchart illustrating an example method.

FIG. 3 is a flowchart illustrating an example method.

FIG. 4 is a block diagram example of a wireless communication system.

FIG. 5 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

The new radio (NR) technology of fifth generation (5G) mobile communication systems is continuously improved to provide higher quality wireless communication. One key feature is to support high capability user equipment (UE), such as customer premise equipment or fixed wireless access (CPE/FWA), to improve uplink (UL) quality. Up to eight (8) transmits (Tx) (antenna ports) for UL transmission is one of such features because legacy UE can support up to 4 Tx.

The current framework is that UE reports capability of coherent level/#group, gNB configures or indicates coherent/#group (set), and set restriction if needed, which is different from coherent/#group (set).

gNB indicates #group in a Downlink Control Information (DCI), if more than one # of groups are determined based on high layer parameter. gNB indicates a precoder for a transmission by a precoding information and/or a number of layers for each group. UE receives coherent/#group (set), and/or restriction, and the DCI, and determines a precoder for a transmission.

The precoding information and the number of layers for the group can be joint-coded in a field.

The precoding information can be a transit precoding matrix indicator (TPMI), a set of parameter values, or a TPMI indicating a set of parameter values.

Table 1 below indicates the #group with corresponding coherent level and TPMI and/or rank.

TABLE 1

| Indication | | TPMI and/or rank |
|---|---|---|
| # of | | (number of layers) |
| groups | | indication: |
| {1, 2, | For 1 group | One field: rank |
| 4, 8} | (full- | 1~8 + 8Tx TPMI |
| | coherent) | |
| | For 2 groups | 2 fields: each indi- |
| | (partial- | cating rank 0~4 + |
| | coherent 1) | 4Tx TPMI |
| | For 4 groups | 4 fields: each indi- |
| | (partial- | cating rank 0~2 + |
| | coherent 2) | 2Tx TPMI |
| | For 8 groups | 8 fields, each indi- |
| | | cating rank 0~1 |
| | (non-coherent) | or 1 8-bit field |

### Embodiment 1: Mapping for Full/Partial/Non Coherent Codebooks

Mapping between values of precoding info (TPMI) and #layers field and parameters of i_{1,1}, i_{1,2}, i_{1,3}, or i₂ for 1 group, 2/4 TPMI and corresponding ranks (0-2/4) for 2/4 group, 8-bitmap for non-coherent.

For full coherent or one group: precoder is based on downlink (DL) codebook scheme. For DL codebook scheme, codebook is defined for each number of layers by a W with a number of layers of columns and number of Tx ports of rows. W is defined as a function of a set of parameters, such as i_{1,1}, i_{1,2}, i_{1,3}, or i₂. i_{1,1}, or i_{1,2}, depend on values of N₁, N₂, O₁, or O₂, which are number antennas in horizontal and vertical directions, and oversampling factors. When such DL codebook scheme is used for UL codebook, mapping a value of rank (number of layers) and TPMI (precoding information) to a precoder in DL codebook scheme is an issue.

The following equation and tables shows the mapping relationship between values of precoding information and #layers field and parameters.

$${φ}_{n} = {e}^{j π n / 2} \\ {θ}_{p} = {e}^{j π p / 4} \\ {u}_{m} \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix} \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

TABLE Y-1
Supported configurations of (N₁, N₂) and (O₁, O₂)

| Number of | | |
|---|---|---|
| CSI-RS | | |
| antenna ports, | | |
| P_{CSI-RS} | (N₁, N₂) | (O₁, O₂) |
| 8 | (2, 2) | (4, 4) |
| | (2, 2) | New added: (1, 1) |
| | (2, 2) | New added: (2, 2) |
| | (4, 1) | (4, 1) |
| | (4, 1) | New added: (1,1) |

TABLE Y-2
Mapping of i_{1,3} to k₁ and k₂ for 2-layer precoding matrix

| | N₁ > N₂ > 1 | | N₁ = N₂ | | N₁ = 2, N₂ = 1 | | N₁ > 2, N₂ = 1 | |
|---|---|---|---|---|---|---|---|---|
| i_{1,3} | k₁ | k₂ | k₁ | k₂ | k₁ | k₂ | k₁ | k₂ |
| 0 | 0 | 0 | 0 | 0 | 0 | 0 | 0 | 0 |
| 1 | 0₁ | 0 | 0 | 0 | 0₁ | 0 | 0₁ | 0 |
| 2 | 0 | 0₂ | 0 | 0₂ | | | 20₁ | 0 |
| 3 | 20₁ | 0 | 0₁ | 0₂ | | | 30₁ | 0 |

TABLE Y-3
Mapping of i_{1,3} to k₁ and k₂ for 3-layer and 4-layer precoding matrix

TABLE Y-4
Codebook for 1-layer precoding matrix using 8 antenna ports

| i_{1,1} | i_{1,2} | i₂ | |
|---|---|---|---|
| 0,1, . . . , N₁O₁ − 1 | 0, . . . , N₂O₂ − 1 | 0, 1, 2, 3 | ${W}_{{i}_{1 , 1} , {i}_{1 , 2} , {i}_{2}}^{( 1 )}$ |

$where {W}_{l , m , n}^{( 1 )} = \frac{1}{2 \sqrt{2}} [ \begin{matrix}{v}_{l , m} \\ {ϕ}_{n} {v}_{l , m}\end{matrix} ]$

TABLE Y-5
Codebook for 2-layer precoding matrix using 8 antenna ports

| i_{1,1} | i_{1,2} | i₂ | |
|---|---|---|---|
| 0, 1, . . . , N₁O₁ − 1 | 0, . . . , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 2 )}$ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] .$
[P_{CSI-RS} should be replaced by 8 for UL 8Tx codebook]
and the mapping from i_{1,3} to k₁ and k₂ is given in Table 5.2.2.2.1-3.

TABLE Y-y
. . .
Codebook for 8-layer precoding matrix using 8 antenna ports

| | i_{1,1} | i_{1,2} | i₂ | |
|---|---|---|---|---|
| N₁ = 4, N₂ = 1 | $0 , … , \frac{{N}_{1} {O}_{1}}{2} - 1$ | 0 | 0, 1 | ${W}_{{i}_{1 , 1} , {i}_{1 , 1} + {O}_{1} , {i}_{1 , 1} + 2 {O}_{1} , {i}_{1 , 1} + 3 {O}_{1} , 0 , 0 , 0 , 0 , {i}_{2}}^{( 8 )}$ |
| N₁ = 2, N₂ = 2 | 0, . . . , N₁O₁ − 1 | 0, . . . , N₂O₂ − 1 | 0, 1 | ${W}_{{i}_{1 , 1} , {i}_{1 , 1} + {O}_{1} , {i}_{1 , 1} , {i}_{1 , 1} + {O}_{1} , {i}_{1 , 2} , {i}_{1 , 2} , {i}_{1 , 2} + {O}_{2} , {i}_{1 , 2} + {O}_{2} , {i}_{2}}^{( 8 )}$ |

where
${W}_{l , {l}^{′} , {l}^{″} , {l}^{′′′} , m , {m}^{′} , {m}^{″} , {m}^{′′′} , n}^{( 8 )} = \frac{1}{\sqrt{8 {P}_{CSI - RS}}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{″} , {m}^{″}} & {v}_{{l}^{″} , {m}^{″}} \\ {φ}_{n} {v}_{l , m} & - {φ}_{n} {v}_{l , m} & {φ}_{n} {v}_{{l}^{′} , {m}^{′}} & - {φ}_{n} {v}_{{l}^{′} , {m}^{′}} & {v}_{{l}^{″} , {m}^{″}} & - {v}_{{l}^{″} , {m}^{″}} & {v}_{{l}^{″} , {m}^{″}} & - {v}_{{l}^{″} , {m}^{″}}\end{matrix} ]$
.[P_{CSI-RS} should be replaced by 8 for UL 8Tx codebook]

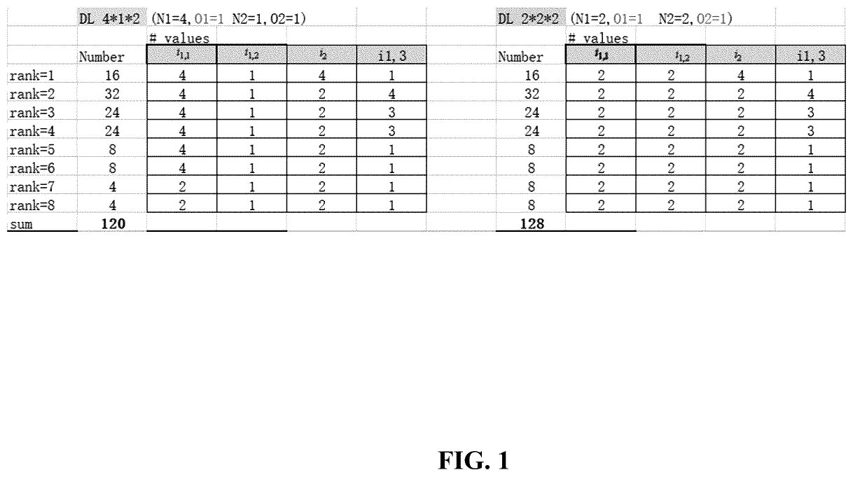

Table 2, also shown as FIG. 1, shows an example of determination of the number of candidate codebook set for each rank.

TABLE 2

| [symbol] | | | | | | [symbol] | | | | |
|---|---|---|---|---|---|---|---|---|---|---|
| | | # values | | | | | # values | | | |
| | Number | [symbol] | [symbol] | i₂ | i1,3 | Number | [symbol] | [symbol] | i₂ | i1,3 |
| rank = 1 | 16 | 4 | 1 | 2 | 1 | 16 | 2 | 2 | 4 | 1 |
| rank = 2 | 32 | 4 | 1 | 2 | 4 | 32 | 2 | 2 | 2 | 4 |
| rank = 3 | 24 | 4 | 1 | 2 | 3 | 24 | 2 | 2 | 2 | 3 |
| rank = 4 | 24 | 4 | 1 | 2 | 3 | 24 | 2 | 2 | 2 | 3 |
| rank = 5 | 8 | 4 | 1 | 2 | 1 | 8 | 2 | 2 | 2 | 1 |
| rank = 6 | 8 | 4 | 1 | 2 | 1 | 8 | 2 | 2 | 2 | 1 |
| rank = 7 | 4 | 2 | 1 | 2 | 1 | 8 | 2 | 2 | 2 | 1 |
| rank = 8 | 4 | 2 | 1 | 2 | 1 | 8 | 2 | 2 | 2 | 1 |
| [symbol] | 120 | | | | | 128 | | | | |

[symbol]

indicates data missing or illegible when filed

As shown from the above table, the number of parameters of i_{1,1}, or i_{1,2} can be determined by N₁*O₁, or N₂*O₂, according to N₁, O₁, N₂, O₂, e.g., configured or indicated by network to UE, or reported from UE to network. The number of parameters of i_{1,1}, or i_{1,2} can be the same for all rank values, or different for different rank values. The number of parameters of i_{1,1}, or i_{1,2} can be determined as for DL codebook scheme by replacing O₁ and/or O₂ by UL O₁ and/or O₂.

The number of parameters of i₂ can be predetermined as 4 for rank 1 and 2 for other rank values, as for DL codebook scheme, or other values configured or indicated by network to UE.

The number of parameters of i_{1,3} can be predetermined as 4, 3, 3 for rank 2, 3 and 4, and 1 for other rank values, as for DL codebook scheme, or other values configured or indicated by network to U.

Then, indicate the number of candidate codebook set for each rank, and mapping of precoding information value and the values of set of parameters of i_{1,1}, i_{1,2}, i_{1,3}, or i₂, to U.

Table 3 shows the determination for mapping between TPMI values and values of parameters. The table shows that each entry indicates a mapping between a TPMI value and parameters of i_{1,1}, i_{1,2}, i_{1,3}, i₂. A set of parameter contains at least one of i_{1,1}, i_{1,2}, i_{1,3}, or i₂ and the precoding information can be the set of parameter values. N1/N2 can be configured. O1/O2 can be configured or determined according to N1/N2, or #layers.

TABLE 3

| TPMI_ | # of | precoding info (Value combinations |
|---|---|---|
| RANK | layers | of i_{1, 1}, i_{1, 2}, i_{1, 3}, or ᵢ₂ |
| field | (RANK) | for each # of layers) |
| 0-3 | 1 | i_{1, 1} = 0, i_{1, 2} = 0, i_{1, 3} = 0, or |
| | | i₂ = 0-3 |
| 4-7 | 1 | i_{1, 1} = 1, i_{1, 2} = 0, i_{1, 3} = 0, or |
| | | i₂ = 0-3 |
| . . . | | |
| 16-17 | 2 | i_{1, 1} = 0, i_{1, 2} = 0, i_{1, 3} = 0, or |
| | | i₂ = 0-1 |
| 18-19 | 2 | i_{1, 1} = 0, i_{1, 2} = 0, i_{1, 3} = 1, or |
| | | i₂ = 0-1 |
| . . . | | |

Table 4 shows that the precoding information can be a TPMI indicating a set of parameter values.

TABLE 4

| TPMI_ | | |
|---|---|---|
| RANK | # of | |
| field | layers | precoding info |
| 0-119 | 1~8 | TPMI (indicating a value combination of |
| | | i_{1, 1}, i_{1, 2}, i_{1, 3}, or i₂ for each # of layers) |

Tables 5 & 6 show associations or mapping of TPMI and a set of parameter values is predetermined for each group.

TABLE 5

| | value combinations of i_{1, 1}, i_{1, 2}, i_{1, 3}, or |
|---|---|
| TPMI | i₂ for 1-layer |
| 0-3 | i_{1, 1} = 0, i_{1, 2} = 0, i_{1, 3} = 0, or i₂ = 0-3 |
| 4-7 | i_{1, 1} = 1, i_{1, 2} = 0, i_{1, 3} = 0, or i₂ = 0-3 |
| . . . | |

TABLE 6

| | value combinations of i_{1, 1}, i_{1, 2}, i_{1, 3}, or |
|---|---|
| TPMI | i₂ for 2- layer |
| 0-1 | i_{1, 1} = 0, i_{1, 2} = 0, i_{1, 3} = 0, or i₂ = 0-1 |
| 2-3 | i_{1, 1} = 0, i_{1, 2} = 0, i_{1, 3} = 1, or i₂ = 0-1 |
| . . . | |

In order to determine value domain of each parameter of i_{1,1}, i_{1,2}, i_{1,3}, i₂ for each rank, the value domain of a parameter can be same or different for different ranks. The TPMI and rank values are jointly indexed according to the following orders: from rank 1 to largest rank value, e.g., 8, or for each rank, combinations of values of the four parameters are ordered in a predefined rule. E.g., i₂ increasing firstly, i_{1,3} secondly, then i_{1,2}, and at last i_{1,1}. or the predefined rule can also be other orders, like i_{1,3} increasing firstly, i₂ secondly, then i_{1,2}, and at last i_{1,1}.

The mapping can be describing with the following steps:

```
Set TpmiRank_i = 0;
      for r = 0 to R
          for i_11 = 0 to I_11
              for i_12= 0 to I_12
                  for i_13 = 0 to I_13
                      for i_2 = 0 to I_2
                    TpmiRank_i = TpmiRank_i +1;
                end for
            end for
        end for
    end for
end for
```

The TpmiRank_i is joint coded index of rank and TPMI (precoder information). Where i_11, i_12, i_13, i_2 are parameters i_{1,1}, i_{1,2}, i_{1,3}, i₂ respectively for a rank value. I_11, I_12, I_13, I_2 are upper value of parameters i_{1,1}, i_{1,2}, i_{1,3}, i₂ respectively for a rank value. Assuming there are 4 values for parameters i_{1,1}, the four values are 0, 1, 2, and 3, and I_11 is 3. Assuming there is 1 value for parameters i_{1,2}, the one value is 0, and I_12 is 0. Assuming there are 2 values for parameters i₂, the 2 value are 0, and 1, I_2 is 1. Assuming there are 4 values for parameters i_{1,3}, the 4 value are 0, 1, 2 and 3, I_13 is 3.

A UE indicates a TpmiRank_i, and the UE determines a rank r at first, then determines the values of parameters i_{1,1}, i_{1,2}, i_{1,3}, and i₂ respectively. The UE calculates a precoder by using the formula for rank r with given parameters i_{1,1}, i_{1,2}, i_{1,3}, and i₂.

For partial-coherent or 2/4 group: the precoding info can be a TPMI from a predetermined precoder set for a corresponding group. The predefined precoder sets are UL 4Tx and UL 2Tx for rank 1-4 and rank 1-2 respectively.

For example, precoding matrix for UL 4Tx rank 1 (single layer) are shown as following tables:

TABLE 6.3.1.5-3
Precoding matrix W for single-layer transmission using
four antenna ports with transform precoding disabled.

| TPMI | W | | | | | | | |
|---|---|---|---|---|---|---|---|---|
| index | (ordered from left to right in increasing order of index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6.3.1.5-5
Precoding matrix W for two-layer transmission using four antenna ports with
transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6

| | Precoding matrix W for three-layer transmission using four antenna ports | | | |
|---|---|---|---|---|
| | with transform precoding disabled. | | | |
| TPMI | W | | | |
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix W for four-layer transmission using four antenna ports
with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

TABLE 6.3.1.5-1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 6.3.1.5-4
Precoding matrix W for two-layer transmission using two antenna
ports with transform precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

As shown in the above table, for each port group, precoding information and number of layers indicate the number of layers (rank) and corresponding TPMI for number of layers larger than zero.

Rank for one or more groups can be zero but cannot be all zeros for all groups.

In order to reduce number of candidate precoder sets for 8Tx for partial coherent cases, TPMI for rank >0 only indicates full coherent precoders, i.e., only part of TPMIs of UL 4Tx/2Tx precoders. As shown in table below. Note that TPMI is not starting from 0. Combine 2 or 4 precoders to an 8Tx precoders with ports mapping relation to align with port indexing for DL precoding.

For example, Table 7 shows precoding information and number of layers for 8 antenna ports.

TABLE 7
Precoding information and number of layers, for 8 antenna ports

| Bit | | Bit | | Bit | |
|---|---|---|---|---|---|
| field | | field | | field | |
| mapped | | mapped | | mapped | For each group of |
| to | For 1-group or full- | to | For each group of 2- | to | 4-group or partial- |
| index | coh | index | group or partial-coh1 | index | coh2 |
| 0 | 1 layer: i_{1, 1}, i_{1, 2}, i_{1, 3}, i₂. | 0 | 0 layer | 0 | 0 layer |
| 1 | 1 layer: i_{1, 1}, i_{1, 2}, i_{1, 3}, i₂. | 1 | 1 layer: TPMI = 12 | 1 | 1 layer: TPMI = 2 |
| . . . | . . . | 2 | 1 layer: TPMI = 13 | 2 | 1 layer: TPMI = 3 |
| 3 | 1 layer: i_{1, 1}, i_{1, 2}, i_{1, 3}, i₂. | . . . | . . . | 3 | 1 layer: TPMI = 4 |
| 4 | 2 layers: i_{1, 1}, i_{1, 2}, i_{1, 3}, | 16 | 1 layer: TPMI = 27 | 4 | 1 layer: TPMI = 5 |
| | i₂. | | | | |
| . . . | . . . | 17 | 2 layers: TPMI = 14 | 5 | 2 layers: TPMI = 1 |
| 9 | 2 layers: i_{1, 1}, i_{1, 2}, i_{1, 3}, | . . . | . . . | 6 | 2 layers: TPMI = 2 |
| | i₂. | | | | |
| 10 | 3 layers: i_{1, 1}, i_{1, 2}, i_{1, 3}, | 24 | 2 layers: TPMI 21 | | |
| | i₂. | | | | |
| . . . | . . . | 25 | 3 layers: TPMI = 3 | | |
| 12 | 3 layers: _{i1, 1}, i_{1, 2}, i_{1, 3,} | . . . | . . . | | |
| | i₂. | | | | |
| . . . | . . . | 28 | 3 layers: TPMI = 6 | | |
| 19 | | 29 | 4 layers: TPMI = 3 | | |
| 20 | | 30 | 4 layers: TPMI = 4 | | |
| . . . | | | | | |
| 119 | 8 layers: i_{1, 1}, i_{1, 2}, i_{1, 3}, | | | | |
| | i₂. | | | | |

For a partially coherent 8TX precoder, the following precoding structures can be used: For Ng=2, i.e., 2 port groups, or partial-coh 1 case, i.e., a first type of partial coherence,

$${[ \begin{matrix}{A}_{1} & {0}_{4 \times rank ( {A}_{2} )} \\ {0}_{4 \times rank ( {A}_{1} )} & {A}_{2}\end{matrix} ]}_{8 \times rank} ,$$

where rank=rank(A1)+rank(A2) is one of 1, 2, . . . , or 8, rank(A1) or rank(A2) can be one of 0-4, and A1 and A2, if not empty, correspond to only FC (full-coh) 4Tx precoders.

The following schemes are for Ng=4, i.e., 4 port groups, or partial-coh 2 case, i.e., a second type of partial coherence:

$${[ \begin{matrix}{A}_{1} & {0}_{2 \times rank ( {A}_{2} )} & {0}_{2 \times rank ( {A}_{3} )} & {0}_{2 \times rank ( A )} \\ {0}_{2 \times rank ( {A}_{1} )} & {A}_{2} & {0}_{2 \times rank ( {A}_{3} )} & {0}_{2 \times rank ( {A}_{4} )} \\ {0}_{2 \times rank ( {A}_{1} )} & {0}_{2 \times rank ( {A}_{2} )} & {A}_{3} & {0}_{2 \times rank ( {A}_{4} )} \\ {0}_{2 \times rank ( {A}_{1} )} & {0}_{2 \times rank ( {A}_{2} )} & {0}_{2 \times rank ( {A}_{3} )} & {A}_{4}\end{matrix} ]}_{8 \times rank}$$

Scheme 1: where rank=rank(A1)+rank(A2)+rank(A3)+rank(A4) is one of 1, 2, . . . , or 8, rank(A1) rank(A2), . . . , or rank(A2) can be one of 0-2, and A1, A2, A3 and A4, if not empty, correspond to only FC 2Tx precoders. Note that this structure is only for per-port-group TPMI discussion, and it may need further port index mapping to align with coherent relation among ports of port groups in a 8-port precoder.

For 4-group, Ng=4, or partial-coh 2 case, there may be another way to reduce number of candidate precoders for 8 port:

Scheme 2: The way is to use two 4Tx precoder ranks and two 4Tx TPMIs corresponding to partial-coh construction. For example,

$${[ \begin{matrix}{A}_{1} & {0}_{4 \times rank ( {A}_{2} )} \\ {0}_{4 \times rank ( {A}_{1} )} & {A}_{2}\end{matrix} ]}_{8 \times rank} ,$$

where rank=rank(A1)+rank(A2) is one of 1, 2, . . . , or 8, rank(A1) or rank(A2) can be one of 0-4, and A1 and A2, if not empty, correspond to only PC (partial-coh) 4Tx precoders.

UE determines to use scheme 1 or scheme 2 depending on the highest coherent capability (or level) of UE for 8Tx.

Scheme 2 has less candidate precoders with less flexibility compared with scheme 1. If the highest coherent capability of UE for 8Tx is partial-coh 2, which means there are non-coherent four 2Tx groups, and the ports within a group are coherent, it is better to have full flexibility for precoder selection for each group, and scheme 1 can be used. If the highest coherent capability of UE for 8Tx is full-coh, or partial-coh 1, the 4-group can be compatible from UE capability perspective, but the requirement of flexibility can be not so high, and scheme 2 can be used.

Note that one coherent level corresponds to one number of port groups. The highest coherent level can be replaced by a lowest number of port groups (e.g., Ng). This can be determined based on UE report or based on network configuration.

For Non-coherent codebook: for 8 Tx ports, full flexibility combinations support any ports to be selected or not. There are totally 255 candidate combinations and specifying non-coherent codebook is an issue.

Solution 1: For non-coherent 8Tx codebook, a precoder and a rank indication is an 8-bit field. The 8-bit field can be transformed into binary number. Each bit corresponds to a respective port. If the i-th bit is a nonzero value, it corresponds to a vector with the i-th port is nonzero, e.g., 1. then combine all the vectors of non-zero bits to form a 8Tx non-coherent precoder.

As shown below, assuming precoder and rank indication is 148, which is 8 bits: 1001 0100 as a binary number, indicates port #0, #3, #5 are non-zero values, corresponding to 3 8Tx vectors respectively. Then the 3 8Tx vectors are normalized.

Index i of non-zero vector vi corresponds to port i and corresponds to a non-zero bit-i in binary number.

$${v}_{0} = [ \begin{matrix}1 \\ 0 \\ 0 \\ 0 \\ 0 \\ 0 \\ 0 \\ 0\end{matrix} ] , {v}_{3} = [ \begin{matrix}0 \\ 0 \\ 0 \\ 1 \\ 0 \\ 0 \\ 0 \\ 0\end{matrix} ] , {v}_{5} = [ \begin{matrix}0 \\ 0 \\ 0 \\ 0 \\ 0 \\ 1 \\ 0 \\ 0\end{matrix} ] , and {W}_{8 \times 3} = [ \begin{matrix}1 & 0 & 0 \\ 0 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0\end{matrix} ]$$

Solution 2: For non-coherent 8Tx codebook, precoder and rank indication can have same structure as Ng=4, that is four ranks (0-2) and four 2Tx TPMIs. For example,

$${[ \begin{matrix}{A}_{1} & {0}_{2 \times rank ( {A}_{2} )} & {0}_{2 \times rank ( {A}_{3} )} & {0}_{2 \times rank ( A )} \\ {0}_{2 \times rank ( {A}_{1} )} & {A}_{2} & {0}_{2 \times rank ( {A}_{3} )} & {0}_{2 \times rank ( {A}_{4} )} \\ {0}_{2 \times rank ( {A}_{1} )} & {0}_{2 \times rank ( {A}_{2} )} & {A}_{3} & {0}_{2 \times rank ( {A}_{4} )} \\ {0}_{2 \times rank ( {A}_{1} )} & {0}_{2 \times rank ( {A}_{2} )} & {0}_{2 \times rank ( {A}_{3} )} & {A}_{4}\end{matrix} ]}_{8 \times rank} ,$$

where rank=rank(A1)+rank(A2)+rank(A3)+rank(A4) is one of 1, 2, . . . , or 8, rank(A1) rank(A2), . . . , or rank(A2) can be one of 0-2, and A1, A2, A3 and A4, if not empty, correspond to only NC (non-coh) 2Tx precoders.

Solution 2 has same number of candidate percoders for 8Tx, but the benefit of solution 2 is precoder for 8Tx can be determined by combining multiple (four) 2Tx precoders similar to that for two 4Tx groups, and no need to define vector.

Solution 3: For non-coherent 8Tx codebook, precoder and rank indication can have same structure as Ng=2, that is two ranks (0-4) and two 4Tx TPMIs. For example, for Ng=2, or partial-coh 1 case,

$${[ \begin{matrix}{A}_{1} & {0}_{4 \times rank ( {A}_{2} )} \\ {0}_{4 \times rank ( {A}_{1} )} & {A}_{2}\end{matrix} ]}_{8 \times rank} ,$$

where rank=rank(A1)+rank(A2) is one of 1, 2, . . . , or 8, rank(A1) or rank(A2) can be one of 0-4, and A1 and A2, if not empty, correspond to only NC 4Tx precoders.

Solution 3 has benefit of less number of candidates for 8Tx non-coh precoders compared to solution 1 and solution 2.

If solution 2 and 3 are allowed for a UE, the UE determines solution 2 or solution 3 depending on the highest coherent capability of UE for 8Tx.

If the highest coherent capability of UE for 8Tx is full-coh, or partial-coh 1, the 4-group can be compatible, but the requirement of flexibility can be not so high, and solution 3 can be used. If the highest coherent capability of UE for 8Tx is partial-coh 2 or non-coh, solution 2 can be used.

Coefficients of elements for 8Tx precoders for partial-coh 1, partial-coh 2, or non-coh:

When combining more than one 4Tx or 2Tx precoders to form a 8Tx precoder, UE determines coefficients of elements for 8Tx precoders according to at least one of:

4Tx or 2Tx precoder without coefficients are used as submatrix to form a 8Tx matrix, e.g., which means the element of 4Tx or 2Tx precoders comprises 0, 1, -1, j, or -j is used without (normalization) coefficients; or
a new coefficient for the 8Tx precoder can be: 1/sqrt(N), where N is an integer, and can be determined by a number of non-zero elements in the 8Tx matrix, a number of ports of the 8Tx precoder (8), or a maximum value of a number of non-zero elements in the 8Tx matrix and a number of ports of the 8Tx precoder (8).

Further, if full power (e.g., mode 2) is enabled, the coefficient of the precoder with full power can be 1/sqrt(N), where N is a number of non-zero elements in the 8Tx matrix.

If full power is not enabled, or for the precoder without full power, coefficient for the 8Tx precoder can be: 1/sqrt(N), where N is an integer, and can be determined by a maximum value of a number of non-zero elements in the 8Tx matrix and a number of ports of the 8Tx precoder (8).

### Embodiment 2: Restrictions for Partial-Coherent or Non-Coherent Codebook

Due to large number of codebook combination candidates, such as several thousands of candidates for partial-coherent, a possible large overhead could occur, e.g., 2 5-bit fields for 2 4-Tx groups which is 10 bits overhead for TPMI and rank indication, and 4 3-bit fields for 4 2-Tx groups which is 12 bits overhead. Therefore, there is a need for restrictions in reality for overhead reduction.

Solution: for partial-coherent, non-coherent or even full-coherent codebook, UE is configured or indicated by a network, e.g., via radio resource control (RRC) signaling, or a medium access control (MAC) control element (CE), at least one of the following restrictions: one or more allowed or disallowed ports, port list, or port groups, one or more allowed or disallowed TPMI and TPMI list for one or all port groups, one or more allowed or disallowed level of coherence for the precoder, one or more allowed or disallowed ranks for one or all port groups, or a maximum rank for one or all port groups.

For restriction that is one or more allowed ports for non-coherent codebook, the number of bits for TPMI and rank indication is equal to the number of allowed ports, and each of the bits correspond to the allowed ports respectively. E.g., ports 0, 1, 2, 3 are allowed ports. Or ports 0, 2, 4, 6 are allowed ports. Or ports 0, 1, 4, 5 are allowed ports.

The restriction that is allowed ports or not allowed ports can be indicated as a predefined port list. Such as port 0, 1, 2, 3, ports 0, 2, 4, 6, or ports 0, 1, 4, 5. TPMI for allowed ports are TPMI candidates. TPMIs for not allowed ports are not included as TPMI candidates.

The restriction that is allowed ports or not allowed ports can be indicated as one or more port groups. Such as port group 0 for 2-group, or port group 0, and 1 for 4-group. For not allowed port groups, TPMI and rank indication is not present.

For restriction that is one or more allowed TPMI, the number of TPMI candidates and rank indication is determined according to the number of allowed TPMIs. E.g., TPMI 0, 1, 2, 3 for rank 1 are allowed TPMI. Or TPMI 0, 2, 4, 6 are not allowed TPMIs.

The restriction that is allowed or not allowed TPMI can be indicated as TPMI list or a TPMI pattern which indicating at least one TPMI.

The restriction that is allowed or not allowed TPMI can be indicated for a port group, or for each of all the port groups.

For the restriction that is one or more allowed or not allowed ranks, for one or all port groups, the TPMI candidate and rank indication can be determined based on these information. The one or more allowed or not allowed ranks, can be indicated for one port group, or for each port group, or for sum of ranks of all port groups.

The restriction that is maximum rank for one or all port groups indicates allowed ranks, i.e., rank 1 to maximum rank, for one port group, or for each port group, or for sum of ranks of all port groups.

These restrictions may be relevant to UE capability. UE may need to report capability about such restriction. E.g., priority of port groups in case of 2 port groups, and/or 4 port groups.

Accordingly, some preferred embodiments may use the following solutions.

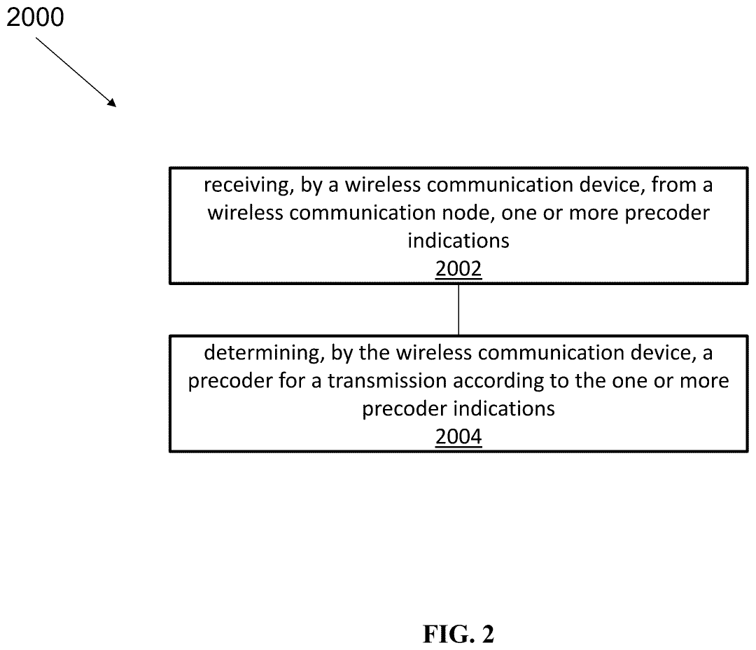

1. A method of wireless communication, as disclosed in FIG. 2, including receiving, by a wireless communication device, from a wireless communication node, one or more precoder indications (2002); wherein each of the precoder indication corresponds to one or more port groups; and determining, by the wireless communication device, a precoder for a transmission according to the one or more precoder indications (2004). Additional details and examples are discussed with respect to embodiments 1-2.

2. The method of solution 1, wherein the precoder indication comprises at least one of a precoding information or a rank.

3. The method of solution 2, wherein the precoding information comprises a transit precoding matrix indicator (TPMI), or a set of parameter values.

4. The method of solution 3, wherein the set of parameter values comprise at least one of i_{1,1}, i_{1,2}, i_{1,3}, or i₂; wherein i_{1,1} and i_{2,2} indicate indexes of precoding vectors of a horizontal direction and a vertical direction, respectively; wherein i_{1,3} indicates a distance between an index of a vector for a layer other than a first layer and an index of a vector for a first layer; or wherein i₂ indicates a phase offset between polarization directions.

5. The method of solution 3, wherein a set of parameters for a rank is determined according to one of: a first configuration information, a predetermined number for the rank, or a predetermined number for all ranks.

6. The method of solution 5, wherein the first configuration information comprises at least one of: a maximum rank for a port group, a maximum rank for a sum of ranks for all port groups, a number of elements of a horizontal direction, a number of elements of a vertical direction, an oversampling factor for a horizontal direction, an oversampling factor for a vertical direction, a number of parameters i_{1,3} for a rank, or a number of parameters i₂ for one or all ranks.

7. The method of solution 2, wherein the precoding information and the rank for the precoder indication are jointly indexed.

8. The method of solution 7, wherein for each rank from rank one to a highest rank value, parameter values of precoding information are ordered according to a predefined rule.

9. The method of solution 8, wherein the parameter values comprise at least one of i_{1,1}, i_{i,2}, i_{1,3}, or i₂, and wherein the predefined rule comprises: increase the parameter by the order of i₂, i_{1,3}, i_{1,2}, then i_{1,1}; or increase the parameter by the order of i_{1,3}, i₂, i_{1,2}, then i_{1,1}.

10. The method of solution 1, wherein the number of port groups is indicated in a downlink control information (DCI) or a radio resource control (RRC) signaling.

11. The method of solution 10, wherein the number of port groups comprises one of: one port group, two port groups, four port groups, eight port groups, or a coherent level including one of: full coherence, a first type of partial coherence, a second type of partial coherence, or non-coherence.

12. The method of solution 1, wherein the wireless communication device further determines a number of the one or more precoder indications or a number of one or more port groups for a precoder indication according to the following: a highest coherent level, or a lowest number of port groups.

13. The method of solution 12, wherein the wireless communication device further determines according to the following: two precoder indications are determined in response to the highest coherent level being either a full coherent level or a first type of partial coherent level; two precoder indications are determined in response to the lowest number of port groups being either one or two; or four precoder indications are determined in response to the highest coherent level being a second type of partial coherent level or the lowest number of port groups being four or eight.

14. The method of solution 1, wherein the wireless communication device further determines coefficients of elements for the precoder for the transmission according to at least one of: a four transmit port (Tx) or a two Tx precoder without coefficients are used as sub-matrix to form an eight Tx matrix for the precoder; or a coefficient for the precoder is: 1/sqrt(N), wherein N is determined by a number of non-zero elements in an eight Tx matrix, a number of ports of an eight Tx precoder, or a maximum value of a number of non-zero elements in an eight transmit matrix and a number of ports of an eight Tx precoder.

15. The method of solution 3, wherein the wireless communication device further determines an association between the precoder indication, and the set of parameters of a corresponding rank.

16. The method of solution 15, where the ranks cannot all be zeros.

17. The method of solution 15, wherein the precoding information for a rank greater than zero indicates full coherent precoder.

18. The method of solution 1, wherein the number of port groups comprises eight port groups, or the coherent level is non-coherence, the precoder indication indicates an N-bit field; wherein the N-bit field can be represented in binary form; wherein each bit corresponds to a corresponding port; wherein a non-zero bit corresponds to a vector with a non-zero element for a corresponding port, and a zero element for other ports; and wherein N is a positive integer.

19. The method of solution 18, wherein the precoder indication further comprises indications that all the vectors of the non-zero bits are used to form a non-coherent precoder for the transmission.

20. The method of solution 1 further comprising: receiving, by a wireless communication device, from a network device, a second configuration indicating at least one of: one or more allowed or disallowed ports, port lists, or port groups, one or more allowed or disallowed TPMI or TPMI lists for one or all port groups, one or more allowed or disallowed levels of coherence for the precoder, one or more allowed or disallowed ranks for one or all port groups, or a maximum rank for one or all port groups; and determining, by the wireless communication device, the precoder for the transmission according to the second configuration.

21. The method of solution 20, wherein the level of coherence of the precoder includes one of full coherence, a first type of partial coherence, a second type of partial coherence, or non-coherence.

22. The method of solution 20, wherein the wireless communication device transmits the second configuration report to the network device.

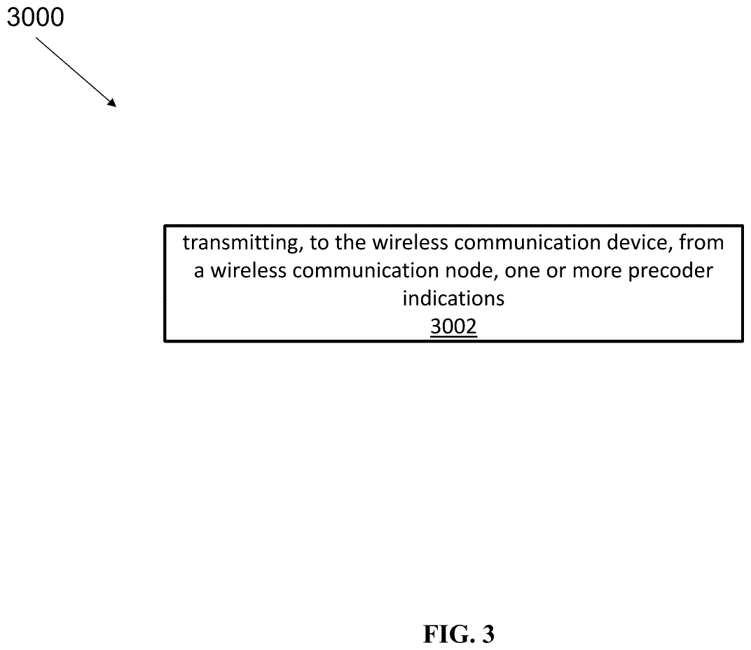

23. A method of wireless communication, as disclosed in FIG. 3, including transmitting, to the wireless communication device, from a wireless communication node, one or more precoder indications (3002); wherein each of the precoder indication corresponds to one or more port groups. Additional details and examples are discussed with respect to embodiments 1-2.

24. The method of solution 23, wherein the precoder indication comprises at least one of a precoding information or a rank.

25. The method of solution 24, wherein the precoding information comprises a transit precoding matrix indicator (TPMI), or a set of parameter values.

26. The method of solution 25, The method of claim 25, wherein the set of parameter values comprise at least one of i_{1,1}, i_{1,2}, i_{1,3}, or i₂; wherein i_{1,1} and i_{1,2} indicate indexes of precoding vectors of a horizontal direction and a vertical direction, respectively; wherein i_{1,3} indicates a distance between an index of a vector for a layer other than a first layer and an index of a vector for a first layer; or wherein i₂ indicates a phase offset between polarization directions.

27. The method of solution 25, wherein a set of parameters for each rank is determined according to one of: a first configuration information, a predetermined number for a rank, or a predetermined number for all ranks.

28. The method of solution 27, wherein the first configuration information comprises at least one of: a maximum rank for a port group, a maximum rank for a sum of ranks for all port groups, a number of elements of a horizontal direction, a number of elements of a vertical direction, an oversampling factor for a horizontal direction, an oversampling factor for a vertical direction, a number of parameters i_{1,3} for a rank, or a number of parameters i₂ for one or all ranks.

29. The method of solution 23, wherein the number of port groups is indicated in a downlink control information (DCI) or a radio resource control (RRC) signaling.

30. The method of solution 29, wherein the number of port groups comprises one of: one port group, two port groups, four port groups, eight port groups, or a coherent level includes one of full coherence, a first type of partial coherence, a second type of partial coherence, or non-coherence.

31. The method of solution 23, wherein the wireless communication device further determines a number of the one or more precoder indications or a number of one or more port groups for a precoder indication according to the following: a highest coherent level, or a lowest number of port groups.

32. The method of solution 31, wherein the wireless communication device further determines according to the following: two precoder indications are determined in response to the highest coherent level being either a full coherent level or a first type of partial coherent level; two precoder indications are determined in response to the lowest number of port groups being either one or two; or four precoder indications are determined in response to the highest coherent level being a second type of partial coherent level or the lowest number of port groups being four or eight.

33. The method of solution 23, wherein the wireless communication device further determines coefficients of elements for the precoder for the transmission according to at least one of: a four transmit port (Tx) or a two Tx precoder without coefficients are used as sub-matrix to form an eight Tx matrix for the precoder; or a coefficient for the precoder is: 1/sqrt(N), wherein N is determined by a number of non-zero elements in an eight Tx matrix, a number of ports of an eight Tx precoder, or a maximum value of a number of non-zero elements in an eight transmit matrix and a number of ports of an eight Tx precoder.

34. The method of solution 23, wherein the number of port groups comprises eight port groups, or the coherent level is non-coherence, the precoder indication indicates an N-bit field; wherein the N-bit field can be represented in binary form; wherein each bit corresponds to a corresponding port; wherein a non-zero bit corresponds to a vector with a non-zero element for a corresponding port, and a zero element for other ports; and wherein N is a positive integer.

35. The method of solution 34, wherein the precoder indication further contains indications that all the vectors of the non-zero bits are used to form a non-coherent precoder for the transmission.

36. The method of solution 23, wherein the wireless communication further comprising: receiving, by a wireless communication device, from a network device, a second configuration indicating at least one of: one or more allowed or disallowed ports, port list, or port groups, one or more allowed or disallowed TPMI and TPMI list for one or all port groups, one or more allowed or disallowed level of coherence for the precoder, one or more allowed or disallowed ranks for one or all port groups, or a maximum rank for one or all port groups; and determining, by the wireless communication device, the precoder for the transmission according to the second configuration.

37. The method of solution 36, wherein the level of coherence of the precoder includes one of full coherence, a first type of partial coherence, a second type of partial coherence, or non-coherence.

38. The method of solution 36, wherein the wireless communication device transmits the second configuration report to the network device.

39. A communication apparatus comprising a processor configured to implement a method recited in any one or more of solutions 1 to 38.

40. A computer readable medium having code stored thereon, the code, when executed, causing a processor to implement a method recited in any one or more of solutions 1 to 38.

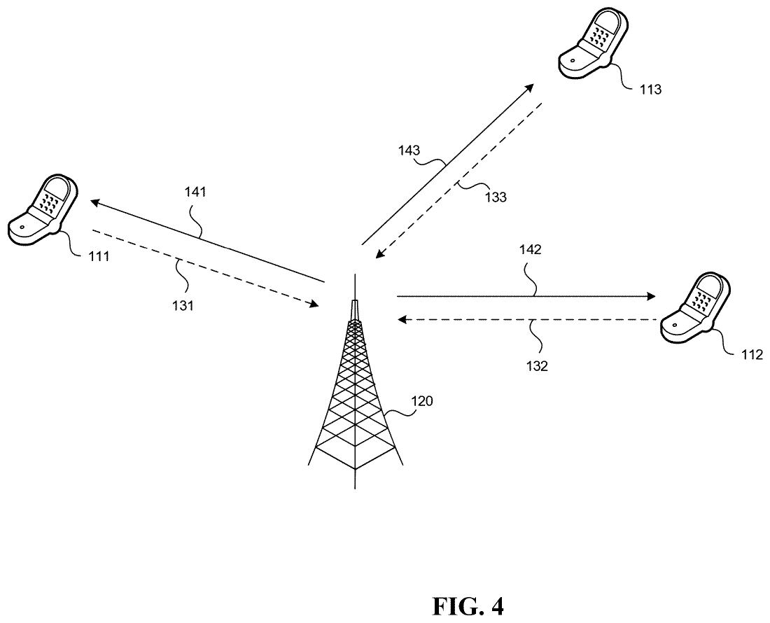

FIG. 4 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

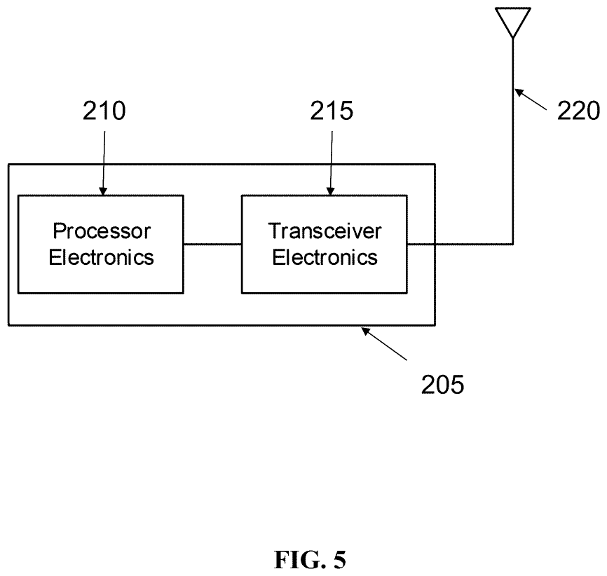

FIG. 5 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

1. A method of wireless communication, comprising:
receiving, by a wireless communication device, from a wireless communication node, one or more precoder indications;
wherein each of the precoder indication corresponds to one or more port groups; and
determining, by the wireless communication device, a precoder for a transmission according to the one or more precoder indications.

2. The method of claim 1, wherein the precoder indication comprises at least one of a precoding information or a rank.

3. The method of claim 2, wherein the precoding information comprises a transit precoding matrix indicator (TPMI), or a set of parameter values.

4. The method of claim 3, wherein the set of parameter values comprise at least one of i_{1,1}, i_{1,2}, i_{1,3}, or i₂;
wherein i_{1,1} and i_{1,2} indicate indexes of precoding vectors of a horizontal direction and a vertical direction, respectively;
wherein i_{1,3} indicates a distance between an index of a vector for a layer other than a first layer and an index of a vector for a first layer; or
wherein i₂ indicates a phase offset between polarization directions.

5. The method of claim 3, wherein a set of parameters for a rank is determined according to one of: a first configuration information, a predetermined number for the rank, or a predetermined number for all ranks:
preferably, wherein the first configuration information comprises at least one of:
a maximum rank for a port group,
a maximum rank for a sum of ranks for all port groups,
a number of elements of a horizontal direction,
a number of elements of a vertical direction,
an oversampling factor for a horizontal direction,
an oversampling factor for a vertical direction,
a number of parameters i_{1,3} for a rank, or
a number of parameters i₂ for one or all ranks.

6. (canceled)

7. The method of claim 2, wherein the precoding information and the rank for the precoder indication are jointly indexed.

8. The method of claim 7, wherein for each rank from rank one to a highest rank value, parameter values of precoding information are ordered according to a predefined rule:
preferably, wherein the parameter values comprise at least one of i_{1,1}, i_{1,2}, i_{1,3}, or i₂, and
wherein the predefined rule comprises:
increase the parameter by the order of i₂, i_{1,3}, i_{1,2}, then i_{1,1}; or
increase the parameter by the order of i_{1,3}, i₂, i_{1,2}, then i_{1,1}.

9. (canceled)

10. The method of claim 1, wherein the number of port groups is indicated in a downlink control information (DCI) or a radio resource control (RRC) signaling:
preferably, wherein the number of port groups comprises one of: one port group, two port groups, four port groups, eight port groups, or a coherent level including one of: full coherence, a first type of partial coherence, a second type of partial coherence, or non-coherence.

11. (canceled)

12. The method of claim 1, wherein the wireless communication device further determines a number of the one or more precoder indications or a number of one or more port groups for a precoder indication according to the following:
a highest coherent level, or
a lowest number of port groups;
preferably, wherein the wireless communication device further determines according to the following:
two precoder indications are determined in response to the highest coherent level being either a full coherent level or a first type of partial coherent level;
two precoder indications are determined in response to the lowest number of port groups being either one or two; or
four precoder indications are determined in response to the highest coherent level being a second type of partial coherent level or the lowest number of port groups being four or eight.

13. (canceled)

14. The method of claim 1, wherein the wireless communication device further determines coefficients of elements for the precoder for the transmission according to at least one of:
a four transmit port (Tx) or a two Tx precoder without coefficients are used as sub-matrix to form an eight Tx matrix for the precoder; or
a coefficient for the precoder is: 1/sqrt(N), wherein N is determined by a number of non-zero elements in an eight Tx matrix, a number of ports of an eight Tx precoder, or a maximum value of a number of non-zero elements in an eight transmit matrix and a number of ports of an eight Tx precoder.

15. The method of claim 3, wherein the wireless communication device further determines an association between the precoder indication, and the set of parameters of a corresponding rank.

16. The method of claim 15, where the ranks cannot all be zeros; or
wherein the precoding information for a rank greater than zero indicates full coherent precoder.

17. (canceled)

18. The method of claim 1, wherein the number of port groups comprises eight port groups, or the coherent level is non-coherence, the precoder indication indicates an N-bit field;
wherein the N-bit field can be represented in binary form;
wherein each bit corresponds to a corresponding port;
wherein a non-zero bit corresponds to a vector with a non-zero element for a corresponding port, and a zero element for other ports; and
wherein N is a positive integer;
preferably, wherein the precoder indication further comprises indications that all the vectors of the non-zero bits are used to form a non-coherent precoder for the transmission.

19. (canceled)

20. The method of claim 1 further comprising:
receiving, by a wireless communication device, from a network device, a second configuration indicating at least one of:
one or more allowed or disallowed ports, port lists, or port groups,
one or more allowed or disallowed TPMI or TPMI lists for one or all port groups,
one or more allowed or disallowed levels of coherence for the precoder,
one or more allowed or disallowed ranks for one or all port groups, or
a maximum rank for one or all port groups; and
determining, by the wireless communication device, the precoder for the transmission according to the second configuration;
preferably, wherein the level of coherence of the precoder includes one of full coherence, a first type of partial coherence, a second type of partial coherence, or non-coherence; or
wherein the wireless communication device transmits the second configuration report to the network device.

21. (canceled)

22. (canceled)

23. A method of wireless communication, comprising:
transmitting, to the wireless communication device, from a wireless communication node, one or more precoder indications;
wherein each of the precoder indication corresponds to one or more port groups.

24. (canceled)

25. (canceled)

26. (canceled)

27. (canceled)

28. (canceled)

29. (canceled)

30. (canceled)

31. The method of claim 23, wherein the wireless communication device further determines a number of the one or more precoder indications or a number of one or more port groups for a precoder indication according to the following:
a highest coherent level, or
a lowest number of port groups;
preferably, wherein the wireless communication device further determines according to the following:
two precoder indications are determined in response to the highest coherent level being either a full coherent level or a first type of partial coherent level;
two precoder indications are determined in response to the lowest number of port groups being either one or two; or
four precoder indications are determined in response to the highest coherent level being a second type of partial coherent level or the lowest number of port groups being four or eight.

32. (canceled)

33. The method of claim 23, wherein the wireless communication device further determines coefficients of elements for the precoder for the transmission according to at least one of:
a four transmit port (Tx) or a two Tx precoder without coefficients are used as sub-matrix to form an eight Tx matrix for the precoder; or
a coefficient for the precoder is: 1/sqrt(N), wherein N is determined by a number of non-zero elements in an eight Tx matrix, a number of ports of an eight Tx precoder, or a maximum value of a number of non-zero elements in an eight transmit matrix and a number of ports of an eight Tx precoder.

34. (canceled)

35. (canceled)

36. The method of claim 23, wherein the wireless communication further comprising:
receiving, by a wireless communication device, from a network device, a second configuration indicating at least one of:
one or more allowed or disallowed ports, port list, or port groups,
one or more allowed or disallowed TPMI and TPMI list for one or all port groups,
one or more allowed or disallowed level of coherence for the precoder,
one or more allowed or disallowed ranks for one or all port groups, or
a maximum rank for one or all port groups; and
determining, by the wireless communication device, the precoder for the transmission according to the second configuration.

37. (canceled)

38. (canceled)

39. A wireless communication device comprising a processor configured to:
receive from a wireless communication node, one or more precoder indications;
wherein each of the precoder indication corresponds to one or more port groups; and
determine a precoder for a transmission according to the one or more precoder indications.

40. A non-transitory computer readable medium having code stored thereon, the code, when executed, causing a processor to implement a method recited in claim 1.
